(19) United States
(12) Patent Application Publication
(10) Pub. No.: US 2014/0056239 A1
(43) Pub. Date: Feb. 27, 2014

(54) METHODS AND APPARATUS FOR POWER CONTROL FOR HIGH-EFFICIENCY SCHEDULING IN TD-SCDMA HSUPA

(71) Applicant: QUALCOMM Incorporated, San Diego, CA (US)

(72) Inventors: Jainqiang Zhang, Beijing (CN); Jiming Guo, Beijing (CN); Mingxi Fan, San Diego, CA (US); Bo Chen, Beijing (CN)

(73) Assignee: QUALCOMM Incorporated, San Diego, CA (US)

(21) Appl. No.: 13/882,246

(22) PCT Filed: Dec. 1, 2010
(86) PCT No.: PCT/CN2010/079348

§ 371 Date: Nov. 14, 2013

(51) Int. Cl. H04W 52/24; H04W 72/12

(52) U.S. Cl. CPC H04W 52/242; H04W 72/1268
USPC 370/329

(57) ABSTRACT

Certain aspects of the present disclosure propose techniques for power control for high-efficiency scheduling for Time Division Synchronous Code Division Multiple Access (TD-SCDMA) High Speed Uplink Packet Access (HSUPA). The basic principle of this power control for a scheduled Enhanced Dedicated Channel (E-DCH) Physical Uplink Channel (E-PUCH) is that all information for a transport block size (TBS) decision is made available at a user equipment (UE). Certain aspects provide a method for wireless communications. The method generally includes receiving, from a UE, an uplink signal, determining a reference uplink power level based on a filtered interference power of the received signal, and transmitting an indication of the reference uplink power level to the UE.

### BACKGROUND

1. Field

Certain aspects of the present disclosure generally relate to wireless communications and, more particularly, to power control in TD-SCDMA HSUPA (High Speed Uplink Packet Access).

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

In an aspect of the disclosure, a method for wireless communications is provided. The method generally includes receiving, from a user equipment (UE), an uplink signal; determining a reference uplink power level based on a filtered interference power of the received signal; and transmitting an indication of the reference uplink power level to the UE.

In an aspect of the disclosure, an apparatus for wireless communications is provided. The apparatus generally includes means for receiving, from a UE, an uplink signal; means for determining a reference uplink power level based on a filtered interference power of the received signal; and means for transmitting an indication of the reference uplink power level to the UE.

In an aspect of the disclosure, an apparatus for wireless communications is provided. The apparatus generally includes a receiver configured to receive, from a UE, an uplink signal; at least one processor configured to determine a reference uplink power level based on a filtered interference power of the received signal; and a transmitter configured to transmit an indication of the reference uplink power level to the UE.

In an aspect of the disclosure, a computer-program product for wireless communications is provided. The computer-program product typically includes a computer-readable medium having code for receiving, from a UE, an uplink signal; determining a reference uplink power level based on a filtered interference power of the received signal; and transmitting an indication of the reference uplink power level to the UE.

In an aspect of the disclosure, a method for wireless communications is provided. The method generally includes transmitting, to a Node B, an uplink signal; receiving, from the Node B, a reference uplink power level based on a filtered interference power of the transmitted uplink signal; determining a transport block size (TBS) based on the received reference uplink power level; and transmitting, to the Node B, a packet according to the TBS.

In an aspect of the disclosure, an apparatus for wireless communications is provided. The apparatus generally includes means for transmitting, to a Node B, an uplink signal; means for receiving, from the Node B, a reference uplink power level based on a filtered interference power of the transmitted uplink signal; and means for determining a TBS based on the received reference uplink power level, wherein the means for transmitting is configured to transmit, to the Node B, a packet according to the TBS.

In an aspect of the disclosure, an apparatus for wireless communications is provided. The apparatus generally includes a transmitter configured to transmit, to a Node B, an uplink signal; a receiver configured to receive, from the Node B, a reference uplink power level based on a filtered interference power of the transmitted uplink signal; and at least one processor configured to determine a TBS based on the received reference uplink power level, wherein the transmitter is configured to transmit, to the Node B, a packet according to the TBS.

In an aspect of the disclosure, a computer-program product for wireless communications is provided. The computer-program product typically includes a computer-readable medium having code for transmitting, to a Node B, an uplink signal; receiving, from the Node B, a reference uplink power level based on a filtered interference power of the transmitted uplink signal; determining a TBS based on the received reference uplink power level; and transmitting, to the Node B, a packet according to the TBS.

### BRIEF DESCRIPTION OF THE DRAWINGS

Aspects and embodiments of the disclosure will become more apparent from the detailed description set forth below when taken in conjunction with the drawings in which like reference characters identify correspondingly throughout.

FIG. 1 is a block diagram conceptually illustrating an example of a telecommunications system in accordance with certain aspects of the present disclosure.

FIG. 2 is a block diagram conceptually illustrating an example of a frame structure in a telecommunications system in accordance with certain aspects of the present disclosure.

FIG. 3 is a block diagram conceptually illustrating an example of a Node B in communication with a user equipment device (UE) in a telecommunications system in accordance with certain aspects of the present disclosure.

FIG. 4 illustrates an example message flow between the Node B and the UE for a Time Division Synchronous Code Division Multiple Access (TD-SCDMA) HSUPA (High Speed Uplink Packet Access) over-the-air (OTA) data rate and resource allocation process, in accordance with certain aspects of the present disclosure.

FIG. 5 is a functional block diagram conceptually illustrating example blocks executed to determine a reference uplink power level in accordance with certain aspects of the present disclosure.

FIG. 6 is a functional block diagram conceptually illustrating example blocks executed to determine a transport block size (TBS) based on a received reference uplink power level in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

### An Example Telecommunications System

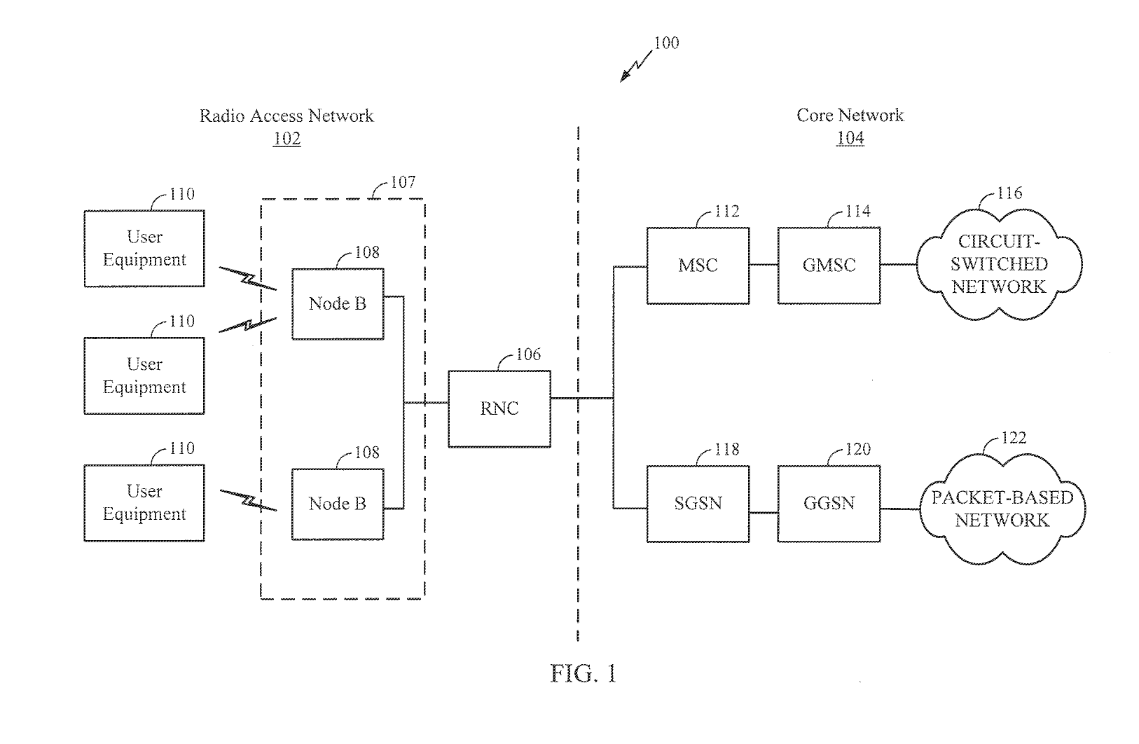

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

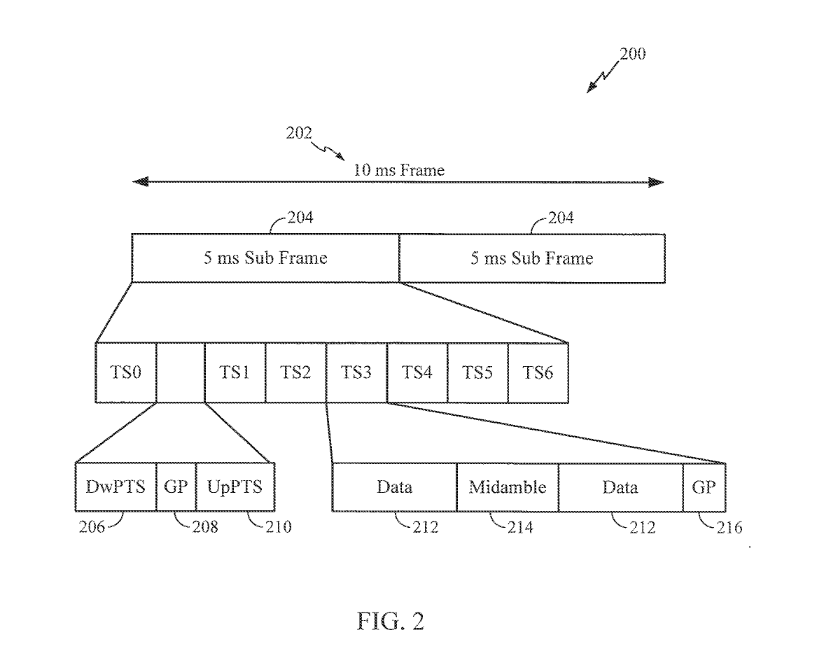

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

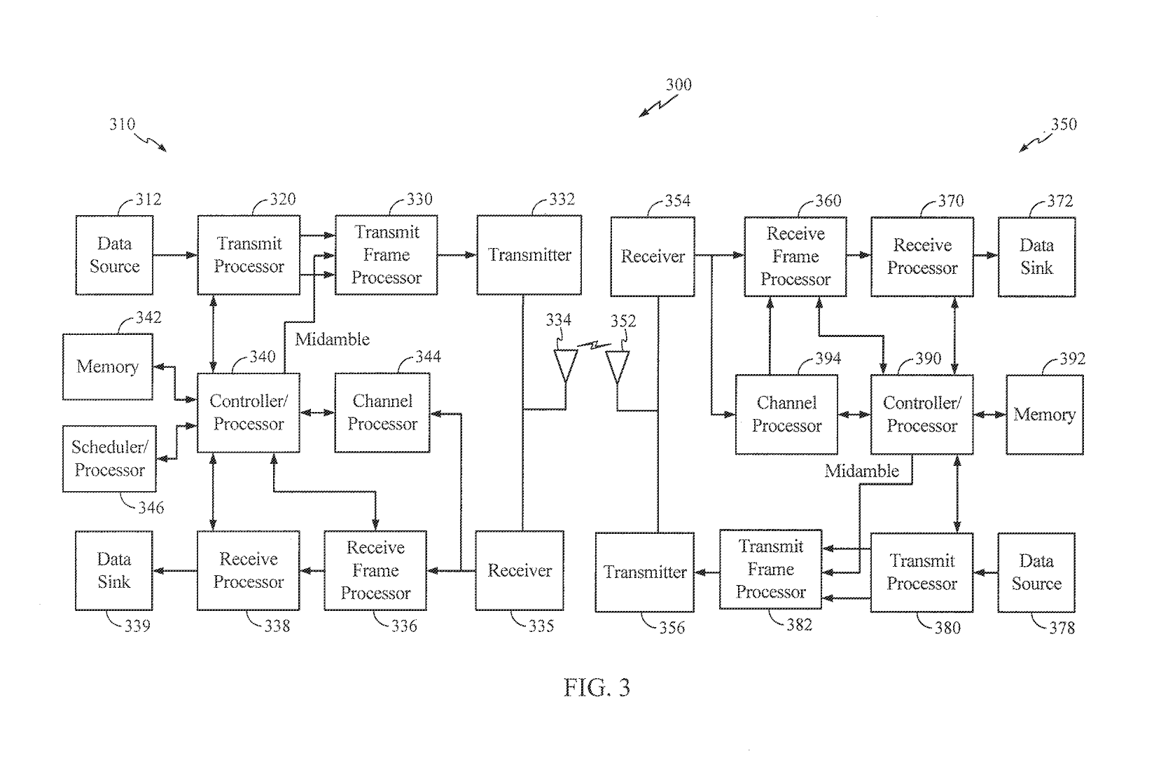

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

### An Example Method for Power Control in TD-SCDMA HSUPA

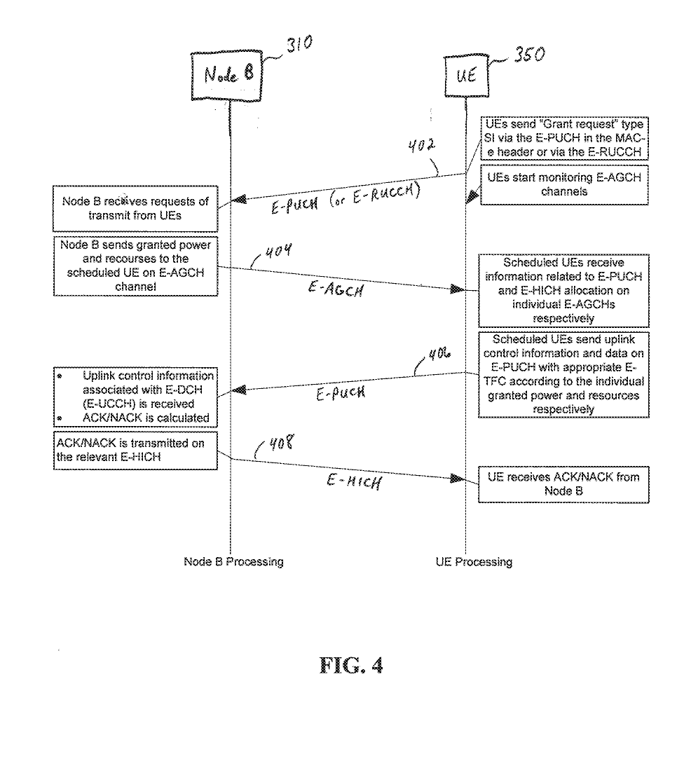

High Speed Uplink Packet Access (HSUPA) has been introduced into the TD-SCDMA specification in 3GPP Rel. 7, and correspondingly in China Communications Standards Association (CCSA) version 3.0. With the high speed uplink capability, a given UE may transmit at high data rates upon assignment via a scheduling grant from the node B scheduler. An overview of data rate and over-the-air (OTA) resource allocation process for TD HSUPA is shown in FIG. 4. The UE 350 may first send a request to a Node B 310 at 402 to include information on its power headroom, buffer size, and flow Quality of Service (QoS) class on E-RUCCH (Enhanced Dedicated Channel (E-DCH) Random Access Uplink Control Channel) upon initiation. Based on request information from UEs in the cell, the Node B uplink scheduler makes a resource grant decision and communicates this via an E-DCH Absolute Grant Channel (E-AGCH) at 404 to the UEs in terms of an E-DCH Physical Uplink Channel (E-PUCH) (a data channel) and an E-DCH Hybrid ARQ Indicator Channel (E-HICH) (a downlink ACK for uplink traffic H-ARQ process) channel allocation, as well as the maximum payload and modulation format allowed. The scheduled UE then proceeds with data transmission at 406 upon the grant and proceed with the request/grant process, where the request could be embedded via an E-DCH Uplink Control Channel (E-UCCH) multiplexed together with uplink HSUPA traffic transmission.

In TD-HSUPA specification in 3GPP Rel. 7 (and correspondingly in CCSA version 3.0), P_{e-base} is a closed-loop quantity controlled by a Node B 310 with a fixed step size. The definition of P_{e-base} is the reference Desired E-PUCH RX power (i.e., the required signal power at the reference code rate with the expected BLER (block error rate)). In fact, P_{e-base} may be expressed in the dB domain as

P_{e-base}=ISCP_{UL}+SNR_{des}+Ω

where Q is a constant factor, SNR_{des} is the required SNR for Node B decoding with the expected initial transmission BLER, and ISCP_{UL} is the interference power over the uplink timeslot configured for E-DCH use.

The first issue is the slow tracking of P_{e-base} compared to a rapidly changing ISCP_{UL}. According to the system simulation and field trial results, ISCP_{UL} has a serious fluctuation, especially when the whole E-PUCH timeslot is allocated to one UE. The probability of E-PUCH CRC (cyclic redundancy check) error depends on its RSCP (received signal code power) and ISCP_{UL}. In order to maintain a desired CRC error probability, P_{e-base} must be quickly adjusted with changes of ISCP_{UL} to get a reasonable C/I (carrier-to-interference ratio) or SNR (signal-to-noise ratio). In implementation, P_{e-base} should track changes of ISCP_{UL}. While in current standard, P_{e-base} can only be incremented or decremented by a fixed step size, which makes it hard for P_{e-base} to track the rapid change of ISCP_{UL}. Consequently P, as P_{e-base} deviates from the value it should be, the UE 350 reports an improper UE power headroom (UPH), and the Node B 310 schedules an improper power grant. According to its definition:

$$UPH = \frac{{P}_{ma x}}{PL \cdot {P}_{e - base}}$$

where Pₘₐₓ denotes the maximum allowed transmit power of the UE 350 and PL denotes the serving cell path loss. Assuming P_{e-base} is well synchronized between the UE and the Node B, it can be seen that:
When P_{e-base} is higher than it should be, the UE reports a lower UPH, and the Node B allocates a smaller gain factor. Then a lower code rate E-PUCH is transmitted at the UE, which results in poor power usage and lower traffic throughput.
When P_{e-base} is lower than it should be, the UE reports a higher UPH, and the Node B allocates a larger gain factor. Then a higher code rate E-PUCH is transmitted at the UE, which results in a high block error of E-PUCH.
   The root cause is that the Node B is aware of the change of UL ISCP, but the UE cannot get it immediately.

The second issue is the P_{e-base} mismatch between the UE 350 and the Node B 310. Due to the transmission failure of E-AGCH or E-HICH, some transmitter power control (TPC) commands generated at the Node B will not reach the UE, which results in a P_{e-base} mismatch between the UE and the Node B.
When P_{e-base} at the Node B is higher than that at the UE, the UE reports a higher UPH, while the Node B allocates a smaller power grant in order to avoid serious inter-cell interference, which results in poor power usage and lower throughput.
When P_{e-base} at the Node B is lower than that at the UE, the UE reports a lower UPH, and the Node B then allocates a smaller power, which also results in poor power usage and lower throughput, as in the former case.

The third issue is the slow tracking of P_{e-base} compared to a rapidly fading channel. Here, it is assumed that ISCP_{UL} is kept constant. When the uplink transmission experiences a good channel condition, the Node B gets a high SNR estimate, and a ‘Down’ TPC command follows to decrease P_{e-base} (otherwise, an ‘Up’ TPC command to increase P_{e-base}). In this way, serious fast fading of wireless channel causes fluctuation of P_{e-base}.

Then, considering the first issue, the conclusion is reached that the power control of P_{e-base} aims to track both channel fading and ISCP_{UL} fluctuation to achieve a proper scheduling decision. Taking into consideration the long period of power control, fixed and small step size, and the variation speed of channel fading and ISCP_{UL} fluctuation, the current TD-HSUPA power control mechanism cannot have an acceptable performance.

Accordingly, what is needed are techniques and apparatus for a TD-HSUPA power control mechanism with increased performance.

According to certain aspects of the present disclosure, the main principle of the power control for scheduled E-PUCH is that all information for a precise TBS (Transport Block Size) decision is available at the UE 350, and the Node B 310 functions less than the existing power control mechanism.

Here a new definition of P_{l-base} (an interference base power level) is introduced. P_{l-base} reflects the filtered uplink interference power and its variation of HSUPA timeslots. At the n^{th} transmission time interval (TTI), P_{l-base(n)} can be expressed as where

P_{l-base}(n)= I̅S̅C̅P̅(n)+γ×g(n)+L_{CDM}(n)

where
α, β and γ are parameters to be specified.

I̅S̅C̅P̅(n)=(1−α)× I̅S̅C̅P̅(n)+α×ISCP(n)
In case of HSUPA occupying 2 or more timeslots, ISCP(n) is the average interference power at these timeslots at the n^{th} TTI.

g(n)={square root over ((1−β)×g²(n−1)+β×[ISCP(n)− I̅S̅C̅P̅{square root over ((1−β)×g²(n−1)+β×[ISCP(n)− I̅S̅C̅P̅{square root over ((1−β)×g²(n−1)+β×[ISCP(n)− I̅S̅C̅P̅\sqrt{(1−β)×g²(n−1)+β×[ISCP(n)− I̅S̅C̅P̅(n)]²}
In case of high variation of uplink interference, the out-loop margin becomes larger compared to the case of stable interference power, no matter how high the absolute interference power is. Meanwhile, the out-loop margin is only updated when the UE is scheduled, such that it responds very slowly, which is why the interference variation should be taken into consideration.

L_{CDM} is used to indicate the performance loss due to the residual intra-cell inter-code interference after JD at the Node B when not all codes are allocated to one UE.

The definition of P_{l-base} is the equivalent transmit power of E-AGCH at the UE side. P_{l-base} can be defined as

P_{l-base}(n)=P_{EAGCH}(n)+G_{BE}(n)

where P_{EAGCH}(n) denotes the instantaneous transmit power of E-AGCH, and G_{BE}(n) denotes the estimated beam-forming gain of the E-AGCH by the Node B.

Now, P_{e-base} is defined as

P_{l-base}(n)=P_{l-base}(n)+P_{l-base}(n)

which is a combination of all information available at the Node B 310 to help the UE 350 to make a proper TBS decision. The value of P_{e-base} is calculated at the Node B and provided to the UE via E-AGCH after quantization.

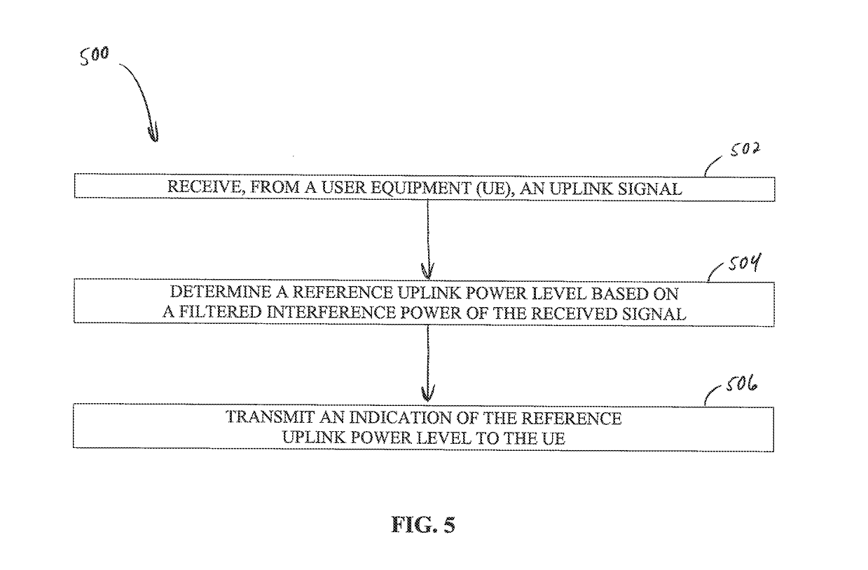

FIG. 5 is a functional block diagram conceptually illustrating example blocks 500 executed to determine a reference uplink power level in accordance with certain aspects of the present disclosure. Operations illustrated by the blocks 500 may be executed, for example, at the processor(s) 338, 340, and/or 346 of the Node B 310 from FIG. 3. The operations may begin at block 502 by receiving, from a UE (e.g., the UE 350), an uplink signal. The operation illustrated by the block 502 may be executed, for example, at the receiver 335 from FIG. 3. For certain aspects, the uplink signal may comprise a request for scheduling information. The request for scheduling information may be received via an E-PUCH or an E-RUCCH.

At block 504, the Node B may determine a reference uplink power level (e.g., P_{e-base}) based on at least a filtered interference power (e.g., I̅S̅C̅P̅(n)) of the received signal. For certain aspects, the reference uplink power level may also be based on an equivalent transmit power (e.g., P_{l-base}) for transmitting the indication of the reference uplink power level, from the perspective of the UE. The equivalent transmit power may be equivalent to an instantaneous transmit power (e.g., P_{EAGCH}(n)) for transmitting the indication of the reference uplink power level added to an estimated beam-forming gain (e.g., G_{BE}(n)) for transmitting the indication of the reference uplink power level. For certain aspects, the reference uplink power level may be based on an interference power level (e.g., P_{t-base}), which includes the filtered interference power.

At block 506, the Node B may transmit an indication of the reference uplink power level to the UE. The operation illustrated by the block 506 may be executed, for example, at the transmitter 332 from FIG. 3. For certain aspects, the Node B may transmit the indication of the reference uplink power level via an E-AGCH.

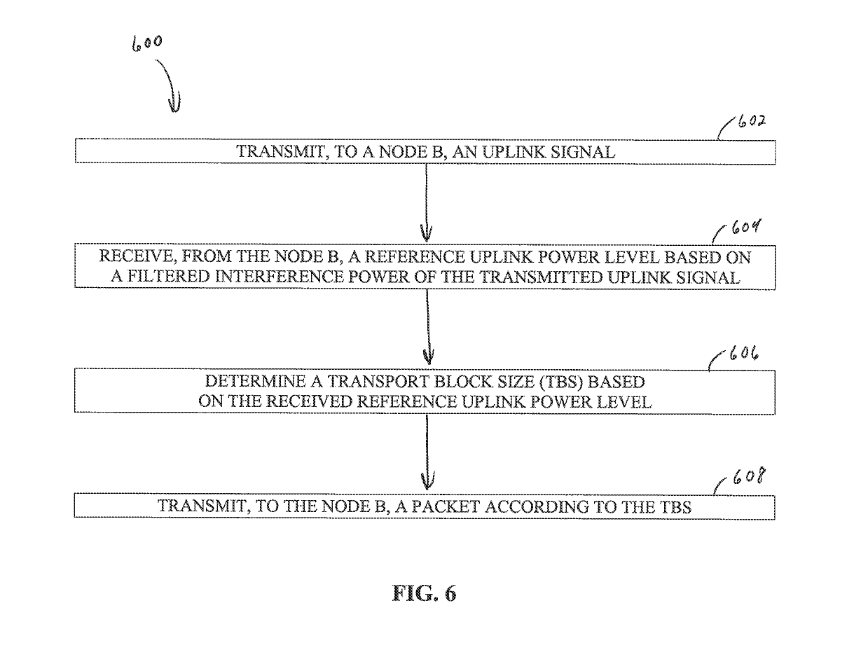

FIG. 6 is a functional block diagram conceptually illustrating example blocks 600 executed to determine a transport block size (TBS) based on a received reference uplink power level in accordance with certain aspects of the present disclosure. Operations illustrated by the blocks 600 may be executed, for example, at the processor(s) 370 and/or 390 of the UE 350 from FIG. 3. The operations may begin at block 602 by transmitting, to a Node B (e.g., the Node B 310), an uplink signal. The operation illustrated by the block 602 may be executed, for example, at the transmitter 356 from FIG. 3. For certain aspects, the uplink signal may comprise a request for scheduling information. The request for scheduling information may be transmitted via an E-PUCH or an E-RUCCH.

At block 604, the UE may receive, from the Node B, an indication of a reference uplink power level based on at least a filtered interference power of the transmitted uplink signal (as described above). The operation illustrated by the block 604 may be executed, for example, at the receiver 354 from FIG. 3.

At block 606, the UE may determine a TBS based on the reference uplink power signal. Techniques for determining the TBS are described in greater detail below. The UE may transmit, to the Node B, a packet according to the TBS at block 608.

At the UE side, the E-AGCH RSCP(RSCP_{EAGCH}(n)) may be measured. The expected SNR per chip at the Node B side can be expressed as

$$\text{?} ( n ) = \text{?} ( n ) - {P}_{i - base} ( n ) - \text{?} ( n ) + H ( n ) - {P}_{i - base} ( n ) = \text{?} ( n ) + \text{?} ( n ) - \text{?} - {P}_{i - base} ( n ) = \text{?} ( n ) + \text{?} - \text{?} ( n ) + \text{?} = \text{?} ( n ) + \text{?} - \text{?}$$

$$\text{?} \text{indicates text missing or illegible when filed}$$

where H(n) is the response of the channel and P_{EPUCH,allowed}(n) is the maximum power at which the UE is allowed to transmit over the E-PUCH.

In some special cases, the mapping of TBS(n) and the SNR_{ENR}(n) is very simple, such that

$$TBS ( n ) = \text{?} arg \{ {SNR}_{required} ( TBS ( n ) ) \text{?} {SNR}_{ex p} ( n ) + 10 log 10 {( [ SF ) - Δ ]}_{\text{?}} ( n ) \}$$

$$\text{?} \text{indicates text missing or illegible when filed}$$

The generalized mapping of TBS and SNR_{ENR}(n) can be expressed with a function ƒ(·) at UE side, where SF is the spread factor, and Δₒᵤₜₗₒₒₚ(n) is the out-loop margin:

$$TBS ( \text{?} ) = f ( \text{?} ( n ) \text{?} ( n ) , \text{?} ( n ) , SF ( n ) , {Δ}_{outloop} ( n ) ) = \text{?} \{ {SNR}_{required} ( TBS ( n ) ) \leq \text{?} ( n ) + \text{?} ( n ) - {P}_{e - base} ( n ) + 10 log 10 {( [ SF ) - Δ ]}_{outloop} ( n ) \}$$

$$\text{?} \text{indicates text missing or illegible when filed}$$

An Example Procedure for Scheduled E-PUCH Transmission

For scheduled HSUPA, when a scheduled HSUPA session is established, the UE may obtain the SNPL (serving and neighbor cell path loss) type and SNPL target via signaling. During the following HSUPA session, the UE may calculate the maximum allowed transmit power (P_{EPUCH,allowed}) based on the SNPL target and its calculated SNPL. When the transport block is too small, the UE may adjust P_{EPUCH,allowed} and zero-padding at the transport block may not be necessary. As P_{e-base} is available at the UE, a power control (PC) bit in E-AGCH is not necessary.

Once a UE is scheduled, the procedure is as follows:
1. The Node B transmits P_{e-base} to the UE via E-AGCH.
2. The UE calculates SNPL based on the measured path-loss of its serving cell and neighbor cells, and calculates its maximum allowed transmit power according to SNPL target.
3. Let C(n)=RSCP_{EAGCH}(n)−P_{e-base}(n) denote the channel condition (including path-loss, fast fading and uplink interference) of this UE. The UE estimates C(n) according to:
   In case of low speed, the instantaneous measurement of C(n) can be used.
   In case of high speed, the filtered C(n), C̅(n)= C̅(n−m)+(1−μ^{m})C(n), can be used, where μ is a speed-dependent parameter and m is the time of the most recent E-PUCH transmission.
4. The UE calculates the proper TBS with the formula below, where C(n) can be replaced with C̅(n) in case of high speed:

TBS(n)=f{P_{EPUCH,allowed}(n),C(n),SF(n),Δₒᵤₜₗₒₒₚ(n)}

With respect to the E-UCCH Number Indicator (ENI) for a scheduled E-PUCH transmission, the repetition number of E-UCCH is very important for the detection of E-PUCH. There are two options for determining ENI: (1) the UE decides ENI based on the current channel condition and its transmit power, while the Node B tries different ENIs and selects the most likely one; or (2) the Node B decides ENI and informs the UE via E-AGCH based on the previous transmission quality.

An Example Procedure for Non-Scheduled E-PUCH Transmission

For non-scheduled HSUPA, the channel condition, C(n), should be power controlled with a specified step size, and the PC bit in E-HICH is most likely used.

First, the following denotations are defined:
Cₖ: the K^{th} code rate
[symbol] : the SINR estimate of k^{th} code rate at n^{th} TTI
SINR_{Target}: SINR target of the reference code rate
Shₖ: SNR shift of the k^{th} code rate compared to the reference code rate in the TBS table at both NB & UE

When a UE is in session of non-scheduled HSUPA, the procedure is as follows:
1. The Node B may decode the E-PUCH and measures its SINR.
   a. If successfully decoded and its code rate is Cₖ,
      Decrease Δₒᵤₜₗₒₒₚ by specified step
      If [symbol] <SINR_{Target}+Shₖ+Δₒᵤₜₗₒₒₚ
         PCCommand=‘UP’
         Respond ACK to UE via E-HICH
      Else
         PCCommand=‘DOWN’
         Respond NAK to UE via E-HICH
      End
   b. If failed to decode,
      Increase Δₒᵤₜₗₒₒₚ by specified step
      PCCommand=‘UP’
      Respond NAK to UE via E-HICH
The UE may adjust its channel condition C(n) according to the power control command from the Node B. Optionally, the ACK/NAK carried via E-HICH may also be used to adjust its out-loop margin Δₒᵤₜₗₒₒₚ. The initial out-loop margin is provided via signaling according to the allocated code and timeslot resource.
2. The formula below may also be used for non-scheduled E-PUCH transmission:

TBS(n)=f(P_{EPUCH,allowed}(n),C(n),SF(n),Δₒᵤₜₗₒₒₚ(n))
a. In order to keep the constant TBS, the required transmit power may be derived.

Alternatively, in case of power constraints due to power capability or SNPL, the UE may adjust its code rate to ensure the desired QoS.

The advantages of certain aspects of the present disclosure are many. First, certain aspects are backward compatible, and only minor changes may be indicated for MAC layer of the standard. Second, with the power control described herein, the UE tries to capture the channel fading based on the latest information of RSCP of E-AGCH. And with the filtered uplink ISCP, the UE may be aware of all information to decide a proper TBS. As far as the TBS decision is concerned, this method is optimal. Third, compared to the existing power control mechanism, certain aspects of the present disclosure have approximately a 10% to 60% performance improvement in slow fading channels.

In one configuration, the Node B 310 or other apparatus for wireless communications includes means for receiving, from a UE, an uplink signal, means for determining a reference uplink power level based on a filtered interference power of the received signal, and means for transmitting an indication of the reference uplink power level to the UE. In one aspect, the aforementioned means may be the receiver 335, the processor(s) 338, 340, and/or 346, and the transmitter 332 configured to perform the functions recited by the aforementioned means. In another aspect, the aforementioned means may be a module or any apparatus configured to perform the functions recited by the aforementioned means.

In one configuration, the UE 350 or other apparatus for wireless communications includes means for transmitting, to a Node B, an uplink signal and a packet according to a determined TBS; means for receiving, from the Node B, a reference uplink power level based on a filtered interference power of the transmitted uplink signal, and means for determining a TBS based on the received reference uplink power level. In one aspect, the aforementioned means may be the transmitter 356, the receiver 354, and the processor(s) 370 and/or 390 configured to perform the functions recited by the aforementioned means. In another aspect, the aforementioned means may be a module or any apparatus configured to perform the functions recited by the aforementioned means.

Several aspects of a telecommunications system have been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read-only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1.-44. (canceled)

45. A method for wireless communications, comprising:
transmitting, to a Node B, an uplink signal;
receiving, from the Node B, an indication of a reference uplink power level based on a filtered interference power of the transmitted uplink signal;
determining a transport block size (TBS) based on the reference uplink power level; and
transmitting, to the Node B, a packet according to the TBS.

46. The method of claim 45, wherein the uplink signal comprises a request for scheduling information.

47. The method of claim 46, wherein the request for the scheduling information is transmitted via an Enhanced Dedicated Channel (E-DCH) Physical Channel (E-PUCH) or an E-DCH Random Access Uplink Control Channel (E-RUCCH).

48. The method of claim 45, further comprising:
determining a serving and neighbor cell path loss (SNPL); and
determining a maximum allowed transmit power based on the determined SNPL and a SNPL target.

49. The method of claim 48, wherein the receiving comprises receiving the indication of the reference uplink power level via an Enhanced Dedicated Channel (E-DCH) Absolute Grant Channel (E-AGCH).

50. The method of claim 49, further comprising:
measuring a received signal code power of the E-AGCH for the n^{th} transmission time interval (TTI); and
determining a channel condition based on an instantaneous channel condition C(n)=RSCP_{EAGCH}(n)−P_{e-base}(n), wherein P_{e-base}(n) is the reference uplink power level for the n^{th} TTI and wherein RSCP_{EAGCH}(n) is the measured received signal code power.

51. The method of claim 50, wherein determining the TBS comprises determining the TBS based on the maximum allowed transmit power and the channel condition.

52. The method of claim 51, wherein determining the TBS further comprises determining the TBS based on a spread factor (SF) and an out-loop margin (Δₒᵤₜₗₒₒₚ(n)).

53. The method of claim 50, wherein determining the channel condition comprises determining a filtered channel condition C̅(n)= C̅(n−m)+(1−μ^{m})C(n), wherein μ is a speed-dependent parameter, m is a time of the most recent E-PUCH transmission, and C(n) is the instantaneous channel condition.

54. The method of claim 45, wherein the reference uplink power level comprises a reference desired Enhanced Dedicated Channel (E-DCH) Physical Uplink Channel (E-PUCH) received power known as P_{e-base}.

55. (canceled)

56. An apparatus for wireless communications, comprising:
means for transmitting, to a Node B, an uplink signal;
means for receiving, from the Node B, an indication of a reference uplink power level based on a filtered interference power of the transmitted uplink signal; and
means for determining a transport block size (TBS) based on the reference uplink power level, wherein the means for transmitting is configured to transmit, to the Node B, a packet according to the TBS.

57-66. (canceled)

67. An apparatus for wireless communications, comprising:
a transmitter configured to transmit, to a Node B, an uplink signal;
a receiver configured to receive, from the Node B, an indication of a reference uplink power level based on a filtered interference power of the transmitted uplink signal; and
at least one processor configured to determine a transport block size (TBS) based on the reference uplink power level, wherein the transmitter is configured to transmit, to the Node B, a packet according to the TBS.

68. The apparatus of claim 67, wherein the uplink signal comprises a request for scheduling information.

69. The apparatus of claim 68, wherein the transmitter is configured to transmit the request for the scheduling information via an Enhanced Dedicated Channel (E-DCH) Physical Channel (E-PUCH) or an E-DCH Random Access Uplink Control Channel (E-RUCCH).

70. The apparatus of claim 67, wherein the at least one processor is further configured to:
determine a serving and neighbor cell path loss (SNPL); and
determine a maximum allowed transmit power based on the determined SNPL and a SNPL target.

71. The apparatus of claim 70, wherein the receiver is configured to receive the indication of the reference uplink power level via an Enhanced Dedicated Channel (E-DCH) Absolute Grant Channel (E-AGCH).

72. The apparatus of claim 71, wherein the at least one processor is further configured to:
measure a received signal code power of the E-AGCH for the n^{th} transmission time interval (TTI); and
determine a channel condition based on an instantaneous channel condition C(n)=RSCP_{EAGCH}(n)−P_{e-base}(n), wherein P_{e-base}(n) is the reference uplink power level for the n^{th} TTI and wherein RSCP_{EAGCH}(n) is the measured received signal code power.

73. The apparatus of claim 72, wherein the at least one processor is configured to determine the TBS by determining the TBS based on the maximum allowed transmit power and the channel condition.

74. The apparatus of claim 73, wherein the at least one processor is further configured to determine the TBS by determining the TBS based on a spread factor (SF) and an out-loop margin (Δₒᵤₜₗₒₒₚ(n)).

75. The apparatus of claim 72, wherein the at least one processor is configured to determine the channel condition by determining a filtered channel condition C̅(n)= C̅(n−m)+(1−μ^{m})C(n), wherein μ is a speed-dependent parameter, m is a time of the most recent E-PUCH transmission, and C(n) is the instantaneous channel condition.

76. The apparatus of claim 67, wherein the reference uplink power level comprises a reference desired Enhanced Dedicated Channel (E-DCH) Physical Uplink Channel (E-PUCH) received power known as P_{e-base}.

77. (canceled)

78. A computer-program product for wireless communications, the computer-program product comprising:
a non-transitory computer-readable medium comprising code for:
transmitting, to a Node B, an uplink signal;
receiving, from the Node B, an indication of a reference uplink power level based on a filtered interference power of the transmitted uplink signal;
determining a transport block size (TBS) based on the reference uplink power level; and
transmitting, to the Node B, a packet according to the TBS.

79-88. (canceled)
